(19) United States
(12) Patent Application Publication
(10) Pub. No.: US 2024/0207658 A1
(43) Pub. Date: Jun. 27, 2024

(54) LUNG DEMAND REGULATOR

(71) Applicant: DRAGER SAFETY AG & CO. KGaA, Lubeck (DE)

(72) Inventors: Paul James RINGER, Co. Durham (GB); Paul TOWNSEND, Northumberland (GB); Iain BRECHTELSBAUER, Whitley Bay (GB)

(21) Appl. No.: 18/528,037

(22) Filed: Dec. 4, 2023

(30) Foreign Application Priority Data
Dec. 22, 2022 (EP) 22216086.3

(51) Int. Cl. A62B 9/02; A62B 18/02

(52) U.S. Cl. CPC A62B 9/027; A62B 18/02

(57) ABSTRACT

There is disclosed a valve assembly for a lung demand regulator of a breathing apparatus. The valve assembly comprises a regulator valve apparatus for regulating a flow of breathing gas, the regulator valve apparatus being actuatable between a closed position in which no flow is permitted and an open position in which flow is permitted. The valve assembly further comprises a lockout mechanism configurable in: i) a lockout configuration in which the regulator valve apparatus is secured in the closed position, and ii) a release configuration in which the regulator valve apparatus is freely moveable. The lockout mechanism comprises an axially compressible spring element. The lockout mechanism is configured such that the spring element is axially compressed during movement of the lockout mechanism between the release configuration and the lockout configuration. Also disclosed is a lung demand regulator and a breathing apparatus comprising a lung demand regulator.

### CROSS-REFERENCE TO RELATED APPLICATIONS

This application claims priority to European Application No. 22216086.3, filed on Dec. 22, 2022, the entire contents of which being fully incorporated herein by reference.

This disclosure relates to lung demand regulators for breathing apparatus and, more specifically to lung demand regulators for self-contained breathing apparatus.

### BACKGROUND OF THE INVENTION

Breathing apparatus commonly comprises a lung demand regulator, which may also be known as a second-stage regulator. The lung demand regulator is configured to deliver breathing gas to the user at a suitable pressure for breathing. In order to conserve breathing gas, the user may need to disable the breathing gas flow when not required, such as when removing the mask. A lockout mechanism may be provided for disabling breathing gas flow. Lockout mechanisms should be reliable and simple to activate.

Therefore, it should be understood that it is desirable to provide improvements to demand regulators in relation to lockout mechanisms.

### SUMMARY OF THE INVENTION

According to a first aspect, there is provided a valve assembly for a lung demand regulator of a breathing apparatus. The valve assembly comprises a regulator valve apparatus for regulating a flow of breathing gas, the regulator valve apparatus being actuatable between a closed position in which no flow is permitted and an open position in which flow is permitted. The valve assembly further comprises a lockout mechanism configurable in: i) a lockout configuration in which the regulator valve apparatus is secured in the closed position, and ii) a release configuration in which the regulator valve apparatus is freely moveable. The lockout mechanism comprises an axially compressible spring element. The spring element is configured to be laterally deflected in a first direction in the lockout configuration and laterally deflected in a second direction different from the first direction in the release configuration. The lockout mechanism is configured such that the spring element is axially compressed during movement of the lockout mechanism between the release configuration and the lockout configuration.

The regulator valve apparatus may comprise one or more of a metering or regulating valve, a moveable or deformable diaphragm, and a linkage configured to transmit movement of the diaphragm to actuate the valve.

The valve regulator apparatus, and optionally the diaphragm and linkage, may be configured to apply sufficient force to the lockout mechanism to move the lockout mechanism from the lockout configuration to the release configuration on application of a first-breath pressure differential to the valve regulator apparatus, optionally to the diaphragm.

The spring element may be elongate, and may extend substantially straight in its natural or unloaded shape or configuration. The spring may extend linearly along a spring axis in its natural or unloaded shape or configuration. “Lateral deflection” of the spring element is a deflection of the spring element away from the natural shape or the spring axis. The lateral deflection may be in a cantilever fashion, with a first end of the spring element being fixed and the second end movable, such that the magnitude of the lateral deflection is non-uniform along the spring element.

As the spring element must be axially compressed during movement of the lockout mechanism between the release configuration and the lockout configuration, the spring element moves ‘over-centre’ during the change of configurations. Therefore, during a first portion of the movement, the spring element resists movement away from the lockout or release configuration and, once over the centre (i.e., the most axially compressed position), the spring element assists movement into the other of the release or lockout configuration.

A magnitude of lateral deflection of the spring element may be different in the lockout configuration and the release configuration. In other words, the lateral deflection in the lockout configuration and release configuration may not be symmetric relative to the neutral position of the spring element.

The first direction and the second direction may be substantially opposing directions.

The lockout mechanism may comprise a pivotable lever in operative connection with the spring element such that angular movement of the pivotable lever adjusts lateral deflection of the spring element.

The pivotable lever may be configured in a first angular position in the lockout configuration and configured in a second angular position in the release configuration.

The pivotable lever may be pivotable about a pivot axis. The pivot axis may be substantially perpendicular to an axial direction of the spring element.

The pivotable lever may comprise a first lever arm for operative connection with the spring element, and a second lever arm configured to engage the regulator valve apparatus in the lockout configuration.

A first end of the spring element may be secured in a fixed position. A second end of the spring element may be secured to the pivotable lever. The second end of the spring element may be moveable with the pivotable lever. The second end of the spring element may be moveable in a substantially arcuate path.

A housing of the lung demand regulator may comprise a fixed spring seat configured to secure the first end of the spring element in a fixed position.

Where the spring element is a helical spring, the fixed spring seat may comprise a spring seat projection formed on a fixed component of the lung demand regulator, the spring seat projection configured to be received within an annulus of the first end of the helical spring.

The pivotable lever may comprise a lever spring seat configured to locate the second end of the spring element.

Where the spring element is a helical spring, the lever spring seat may comprise a moveable spring seat projection formed on the pivotable lever (and optionally the first lever arm), the moveable spring seat projection configured to be received within an annulus of the second end of the helical spring.

The valve assembly may further comprise a detent mechanism configured to at least partially secure the lockout mechanism in the lockout configuration.

The detent mechanism may comprise a retaining feature formed on the pivotable lever which engages a complementary feature to thereby partially retain the pivotable lever in the lockout configuration. The complementary feature may be a pivot pin of a pivoting lever of the lockout mechanism or the regulator valve apparatus.

The axially deformable spring element may be a helical spring.

The lockout mechanism may be configured to be moved from the release configuration to the lockout configuration by the application of force on an activation component of the lockout mechanism by a user. The activation component may be a lever or button which is pressable by a user.

According to a second aspect, there is provided a lung demand regulator comprising a valve assembly according to the first aspect. The lung demand regulator may further comprise a housing within which the valve assembly is located. The lung demand regulator may further comprise an inlet for providing breathing gas to the regulator valve assembly, and an outlet for delivering breathing gas to a user, or to a facemask to be worn by a user.

According to a third aspect, there is provided a breathing apparatus comprising a lung demand regulator according to the second aspect, and optionally further comprising a face mask for connection to the lung demand regulator. The face mask may comprise a complementary connector for releasable connection to the connection mechanism of the lung demand regulator.

The aspects described herein provide a mechanism for automatically disabling the flow of breathing gas through the lung demand regulator. The mechanism described provides clear tactile feedback to the user of the breathing apparatus and provides a robust yet sensitive lockout function. The mechanism may provide improved safety as a user may engage the lockout mechanism more reliably and have more confidence in the lockout, particularly when wearing other personal protective equipment such as gloves, masks, and helmets, or in loud, emergency environments when visual and audible feedback may be less reliable or absent.

### BRIEF DESCRIPTION OF THE DRAWINGS

Arrangements of the invention will now be described, by way of example, with reference to the accompanying drawings, in which:

FIG. 1 schematically shows a breathing apparatus according to an example arrangement comprising a breathing mask and a lung demand regulator;

FIG. 2 schematically shows a breathing mask according to an example arrangement comprising a demand regulator;

FIG. 3 schematically shows a cross-sectional view of a lung demand regulator according to an example arrangement. The plane of the cross-sectional view shown in FIG. 3 is illustrated in FIG. 2.

FIGS. 4A and 4B respectively and schematically show a side view and a cross-sectional views of a valve assembly of lung demand regulator of FIG. 3 in a release configuration according to an example arrangement. The plane of the cross-sectional view shown in FIG. 4B is the same as that in FIG. 3.

FIGS. 5A and 5B respectively and schematically show a side view and a cross-sectional views of the valve assembly of FIG. 4 in lockout configuration according to an example arrangement. The plane of the cross-sectional view shown in FIG. 5B is the same as that in FIG. 3.

FIGS. 6A, 6B, and 6C schematically show cross sectional views of a spring element of the lung demand regulator in the release configuration, an intermediate configuration during movement between the release and lockout configurations, and the lockout configuration

### DETAILED DESCRIPTION OF THE INVENTION

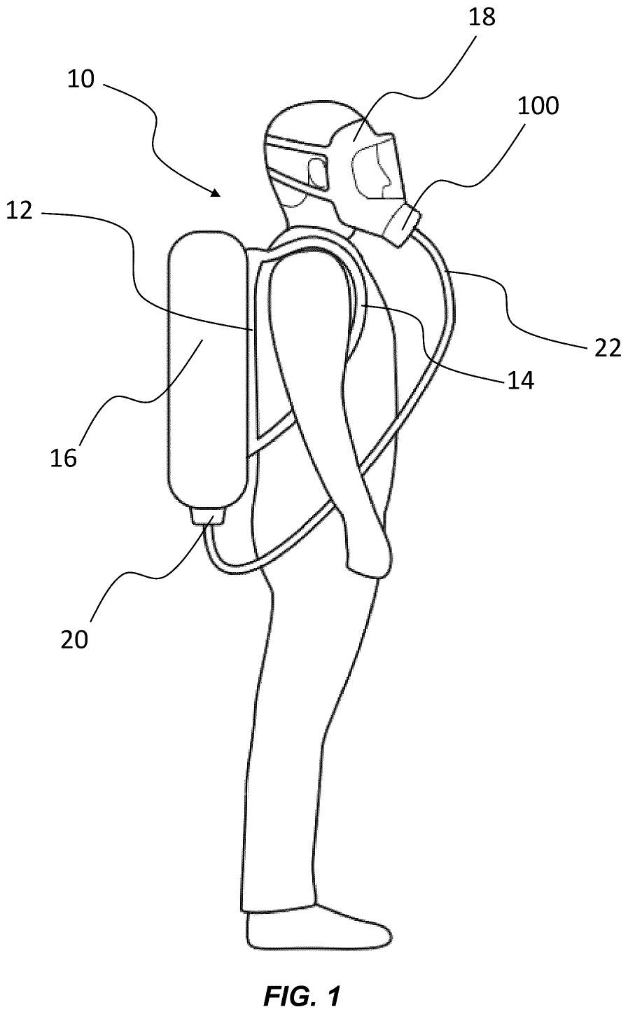

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a hose or flexible conduit 22 to the lung demand regulator 100, to thereby deliver breathing gas to the user wearing the face mask 18 on demand. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus is a self-contained breathing apparatus (SCBA), but it should be understood that the lung demand regulator may also have applications in other types of breathing apparatus, such as self-contained underwater breathing apparatus (SCUBA) and emergency escape breathing apparatus.

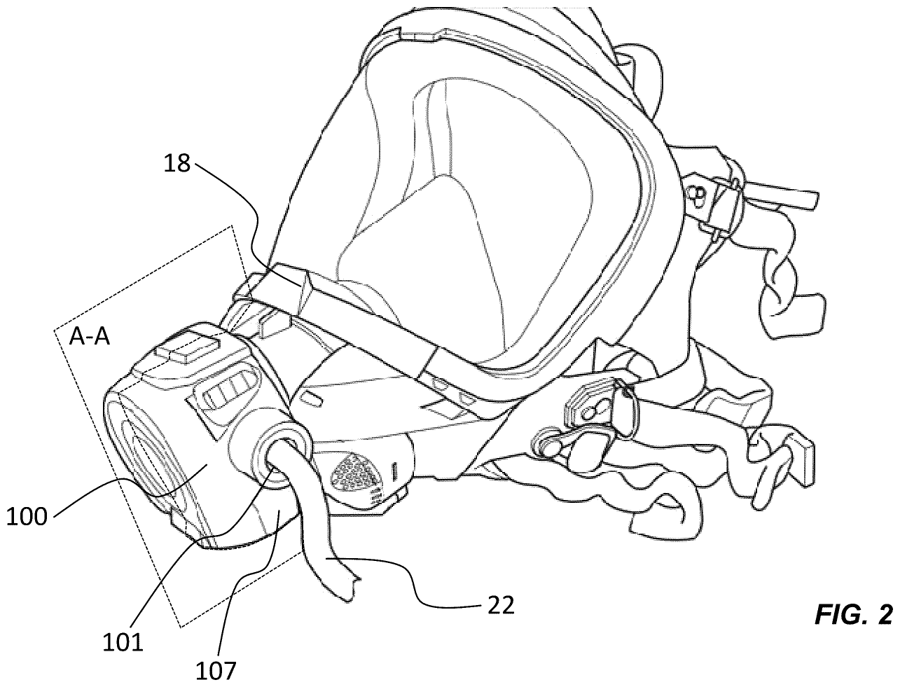

FIG. 2 schematically shows a face mask 18 attached to the regulator 100. As shown in more detail in FIG. 2, a hose 22 of the pneumatics system 20 is connected to an inlet 101 of the regulator 100 to provide breathing gas from the cylinder 16. The pneumatics system 20 may comprise a first-stage pressure reducer which reduces the pressure of the breathing air from the cylinder which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided.

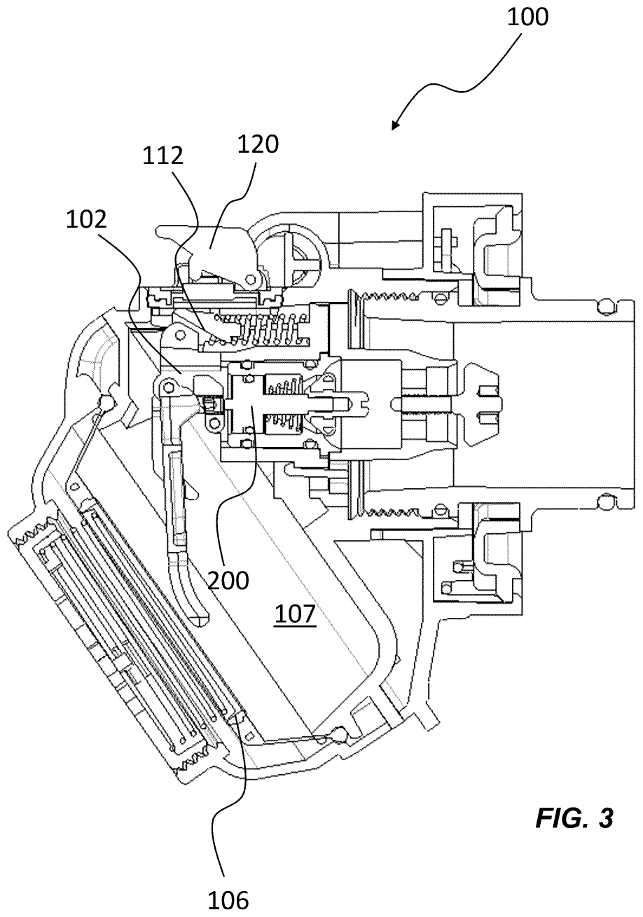

FIG. 3 schematically shows the regulator 100 in more detail. FIG. 3 shows a cross-sectional view of the regulator 100 on the plane A-A shown in the FIG. 2.

As shown in FIG. 3, the regulator 100 comprises a valve assembly 200 for regulating a flow of breathing gas. The valve assembly 200 comprises a regulator valve apparatus 102 for regulating a flow of breathing gas. The regulator valve apparatus 102 comprises a valve 104 that is actuatable between a closed position in which no flow is permitted and an open position in which flow is permitted. The valve 104 comprises a plunger 122, a spring 124, and a seal 126. When in the closed configuration, the seal 126 contacts a seal seat 128, thereby substantially preventing the breathing gas from flowing through the valve 104. When in an open configuration, the seal 126 is lifted from the seal seat 128 and thereby permits breathing gas to flow through the valve 104.

The valve 104 of the regulator valve apparatus 102 is actuated by a flow regulation lever 105. The flow regulation lever 105 is pivotable about a flow regulation lever pivot 108. The flow regulation lever 105 is mechanically linked to the seal 126 such that the further the flow regulation lever 105 rotates in an anticlockwise direction, the further the seal 126 will be lifted away from the seal seat 128, increasing the rate of flow of breathing gas.

The regulator valve apparatus 102 further comprises a diaphragm 106. The diaphragm 106 is configured to move or deform when there is a difference in pressure between an internal chamber 107 of the regulator 100 and the ambient pressure. The flow regulation lever 105, which comprises a flow regulation lever foot 110, is configured to contact the diaphragm 106 and be rotated as a result of movement of the diaphragm 106. It should be understood that the flow regulation lever 105 therefore forms part of a linkage configured to transmit movement of the diaphragm 106 to actuate the valve 104.

Starting from a state where the valve 104 is in the closed configuration and there is no breathing gas flowing, the user can inhale causing a drop in pressure in the regulator chamber 107 compared to the ambient pressure. The pressure differential causes the diaphragm 106 to move inwards. As the diaphragm 106 moves inwards, the flow regulation lever foot 110 is contacted by the diaphragm 106, causing the flow regulation lever 105 to rotate anticlockwise. The resulting anticlockwise movement is translated to the plunger 122, lifting the seal 126 off the seal seat 128. As a result, breathing gas can begin to flow. In many examples, this process will occur rapidly so as not to deprive the user of breathing gas as they inhale. In some configurations, the regulator valve apparatus 102 may be balanced such that, in a neutral position with no pressure differential across the diaphragm 106, the seal 126 is slightly separated from the seal seat 128 (i.e., a nearly-closed configuration) to provide a small constant flow of breathing gas to maintain positive pressure in the face mask 18, thereby preventing ambient gas ingress.

Once the user stops inhaling, there is generally a pause before they begin to exhale. During this pause, breathing gas continues to flow through the valve 104. The flowing breathing gas gradually increases the pressure inside the regulator chamber 107. The pressure further increases once the user begins to exhale. The pressure continues to increase until such point where the pressure in the regulator chamber 107 exceeds the ambient pressure, causing the diaphragm 106 to move outwards. As the diaphragm 106 moves outwards, the flow regulation lever foot 110 and thus the flow regulation lever 105 are no longer being held in place. Resultingly, the spring 124 inside the valve 104 overcomes the forces of the incoming supply of breathing gas, moving the seal 126 back onto, or close to, the seal seat 128. The valve 104 is now returned to the closed or nearly-closed configuration, where the cycle can repeat.

At certain points during use of the breathing apparatus 10, the user may wish to cease the flow of breathing gas, for example, when the user disconnects the regulator 100 from the face mask 18, or if the regulator 100 requires a manual reset.

In this example, the regulator 100 is provided with a lockout mechanism 112. The lockout mechanism 112 is configurable in: i) a lockout configuration in which the regulator valve apparatus 102 is secured in a closed position, and ii) a release configuration in which the regulator valve apparatus 102 is freely moveable. In this example, the lockout mechanism 112 is formed as part of the regulator valve apparatus 102.

The lockout mechanism comprises an axially compressible spring element 114. In this example, the spring element 114 is a helical spring formed from spring steel, but it will be appreciated that other forms of axially compressible spring element could be used, such as a hydraulic or gas spring or an element formed from resiliently deformable material. The spring element 114 is elongate and will be substantially straight in its natural or unloaded shape or configuration. In other words, the spring element 114 extends linearly along a notional spring axis in its natural or unloaded shape or configuration.

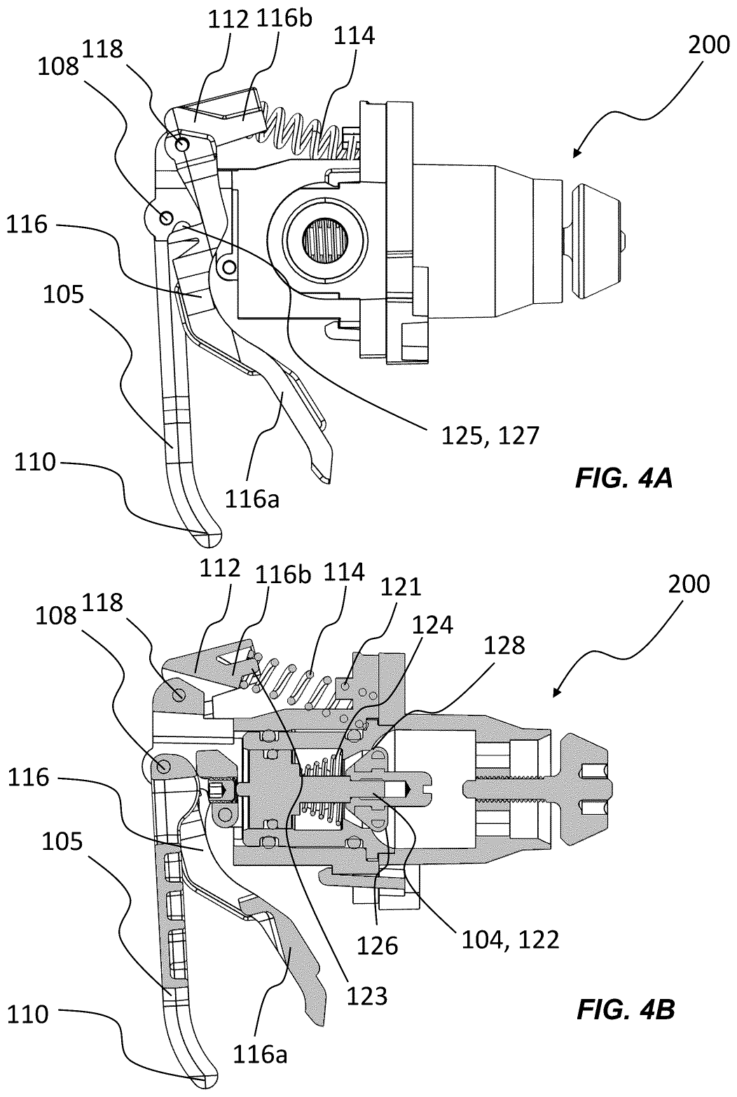

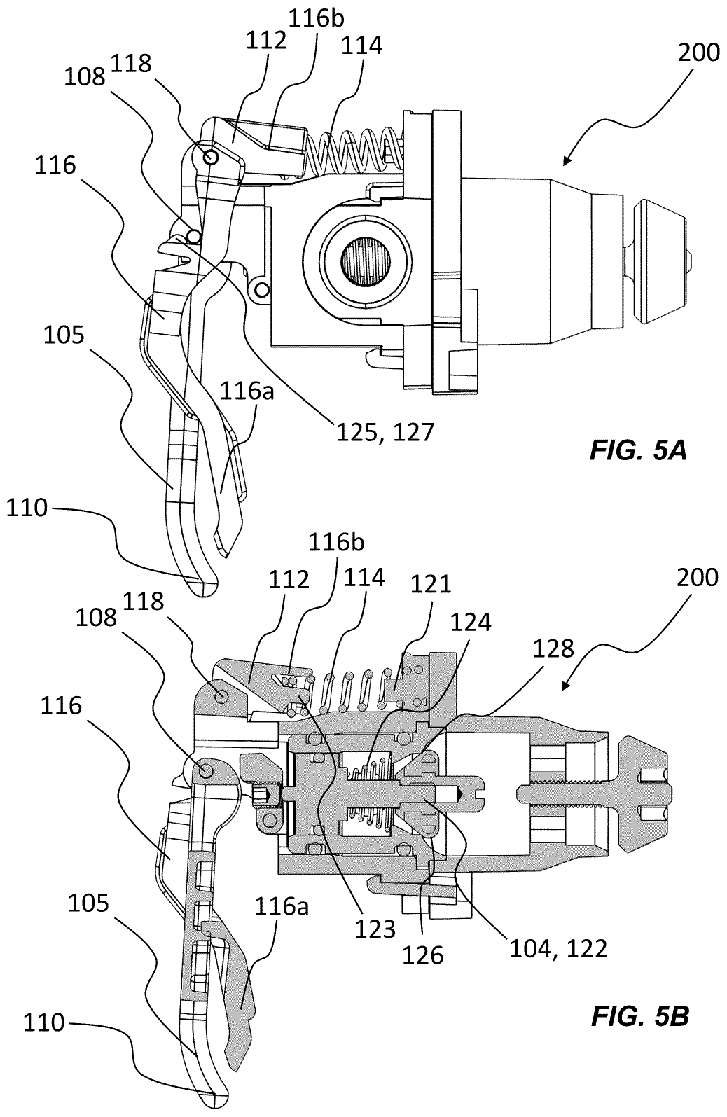

In order to show the operation of the lockout mechanism 112 in more detail, the valve assembly 200 is shown in isolation in FIGS. 4A, 4B, 5A, and 5B. FIGS. 4A and 4B show the valve assembly 200 with the lockout mechanism 112 in the release configuration, while FIGS. 5A and 5B show the valve assembly 200 with the lockout mechanism 112 in the lockout configuration. FIGS. 4A and 5A show a side view of the valve assembly 200, while FIGS. 4B and 5B show cross-sectional views through the valve assembly on the same plane as FIG. 3.

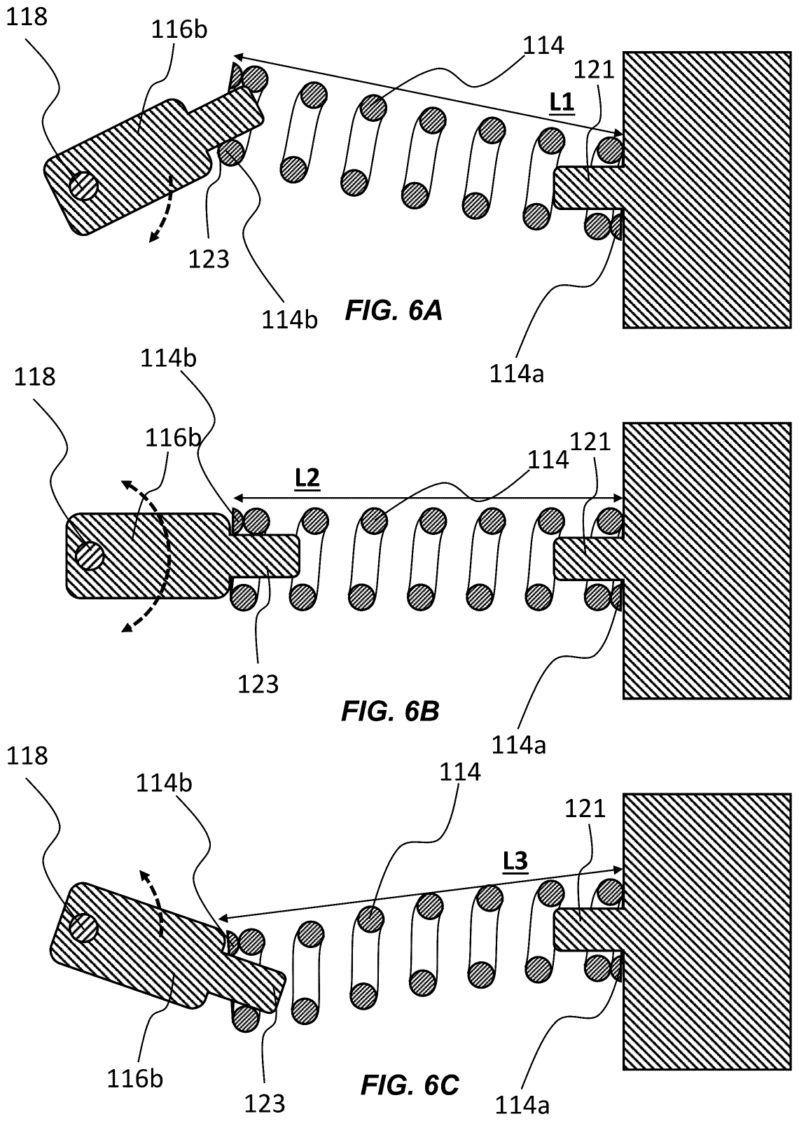

Referring to these Figures, it will be appreciated that the spring element 114 is configured to provide a biasing force to assist in securing the lockout mechanism 112 in its release and lockout configurations. In order to further illustrate the function of the lockout mechanism, and the spring element 114 in particular, a schematic representation of the spring element 114 is shown in FIGS. 6A, 6B, and 6C, in the release configuration, an intermediate position, and the lockout configuration, respectively.

As shown in FIGS. 4A, 4B, and 6A, which represent the release configuration of the lockout mechanism 112, the spring element 114 is configured to be laterally deflected in the upward direction as shown in the Figures.

In contrast, as shown in FIGS. 5A, 5B, and 6C, which represent the lockout configuration of the lockout mechanism 112, the spring element is configured to be laterally deflected in the downward direction as shown in the Figures.

As shown in FIG. 6B, during movement between the release configuration and the lockout configuration, the spring element 114 is configured to be axially compressed.

It should be understood, particularly when observing FIGS. 6A, 6B, and 6C, that the spring element 114 is axially compressed during movement of the lockout mechanism between the release configuration and the lockout configuration. In particular, the spring element 114 moves ‘over-centre’ during the change of configurations.

In the context of this disclosure, the lateral deflection of the spring element 114 is a deflection of the spring element away from a straight shape, or from the notional spring axis. A first end 114a of the spring element 114 is fixed and a second end 114b of the spring element 114 is movable, such that the magnitude of the lateral deflection away from the notional spring axis is non-uniform along the spring element 114.

In order to apply a laterally deflecting force to the spring element 114 to move the lockout mechanism 112 (and thus the spring element 114) between its release and lockout configurations, the spring element 114 is operatively coupled to a pivotable retention lever 116. The retention lever is pivotable about a pivot axis 118, formed by a pivot pin. The pivot pin and thus the pivot axis 118 is perpendicular to the axial direction of the spring element 114.

The retention lever 116 comprises a first lever arm 116a, which extends at a first angular position, and a second lever arm 116b, which extends at a second angular position. The first lever arm 116a is a retaining lever arm 116a, which engages the flow regulation lever 105 in the lockout configuration in order to secure the flow regulation lever 105 and thus the diaphragm 106 in a lockout configuration in which the valve 104 is closed. The second lever arm 116b is an actuation lever arm 116b, which engages the non-fixed second end 114b of the spring and is configured to therefore move the second end 114b of the spring element 114 in an arcuate path relative to the pivot axis 118. In addition, as shown in FIG. 3, the actuation lever arm 116b is configured to be actuated by an activating button 120 on the exterior of the regulator 100, in order that the user can apply a pivoting force to the actuation lever arm 116b to pivot the retention lever 116 about the pivot axis 118.

In order to secure the spring element 114, the regulator 100 comprises a fixed spring seat protrusion 121, which has a cylindrical form approximately the same diameter as the internal diameter of the spring element 114. The annulus of the first end 114a of the spring element 114 is arranged to encircle the fixed protrusion 121, and is therefore fixed in position. The opposing second end 114b of the spring element 114 is secured to the actuation lever arm 116b. The actuation lever arm 116b comprises a lever spring seat protrusion 123, which likewise has a cylindrical form approximate the same diameter as the internal diameter of the spring element 114. The annulus of the second end 114b of the spring element 114 is arranged to encircle the lever protrusion 123, and is therefore secured to the actuation lever arm 116b. Angular movement of the retention lever 116 about the pivot axis 118 therefore adjusts a lateral deflection of the spring element 114.

Furthermore, the spring seats 121, 123 may be configured to provide a different load on the spring element 114 when moving in one direction compared to the other. Such a configuration may provide different over-centre characteristics dependent upon the movement direction, which may bias the lockout mechanism 112 to move more easily in one direction than the other. In particular, less force may be required to move the lockout mechanism 112 from the lockout configuration to the release configuration compared to moving from the release configuration to the lockout configuration.

During use of the breathing apparatus 10, the lockout mechanism 112 will be in the release position, as shown in FIGS. 4A, 4B, and 6A. In this position, the spring element 114 is laterally deflected in the upward direction, and has an effective axial length L1 between the fixed protrusion 121 and the lever protrusion 123. The retention lever 116 is in a first angular position. In order to move the spring element 114 back towards the notional spring axis (and an axially straight position), as shown by the arrow in FIG. 6A, the lever protrusion 123, and thus the second end 114b of the spring element 114 must move arcuately, which will cause an axial compression of the spring element 114. Therefore, the spring element 114 will oppose this movement, as it will oppose axial compression. Absent any external force upon the lockout mechanism 112, the spring element 114 and the retention lever 116 will be retained in position by the natural spring forces of the spring element 114. A stop element may be provided to prevent further movement of the retention lever 116 in the anti-clockwise direction.

When it is desired to activate the lockout mechanism 112 (i.e., move the lockout mechanism 112 to the lockout configuration), a force is applied to the actuation lever arm 116b via the activating button 120 by the user. This force pivots the retention lever 116 in the clockwise direction as shown, and therefore overcomes the opposing force applied by the spring element 114. As the retention lever 116 pivots, the lateral deflection of the spring element 114 decreases and the axial compression increases until the axial compression of the spring element 114 reaches a maximum, as shown in FIG. 6B.

In FIG. 6B, the spring element 114 is maximally axially compressed and has an effective axial length L2, which is less than L1. In this position, the spring element 114 is at an unstable ‘centre’. The spring element 114 applies a force which will urge the actuating lever arm 116b away from this position in either the clockwise or anti-clockwise directions, as illustrated by the arrow in FIG. 6B.

If the force applied to the actuation lever arm 116b continues, then the retention lever 116 will continue to pivot clockwise, and the spring element 114 will then assist in urging the retention lever 116 in the clockwise direction, as it releases the stored energy from its axial compression during the first phase of the movement.

The retention lever 116 will thus continue to rotate clockwise (even in the absence of external force from the user to the position illustrated in FIGS. 5A, 5B, and 6C, i.e., the lockout configuration. The spring element 114 is once again laterally deflected, now in the downwards direction, and will apply a biasing force retain the retention lever 116 in this position. The spring element 114 now has an effective axial length L3 between the fixed protrusion 121 and the lever protrusion 123 which, in this example is less than L1 but also more than L2. In other examples, it may be equal to or greater than L1. The retention lever 116 is configured in a second angular position. Pivoting in the anti-clockwise direction back towards the release configuration will be opposed by the spring element 114, as it would require the spring element 114 to be axially compressed once again. A further stop element may be provided to prevent further movement of the retention lever 116 in the clockwise direction.

Overall, it should be appreciated that during a first portion of the movement between the release and lockout configurations, the spring element 114 resists movement and, once over the centre (i.e., the most axially compressed position), the spring element assists movement into the other configuration. The spring element 114 therefore naturally retains the retention lever 116 (and therefore the lockout mechanism 112 as a whole) in both of the release and lockout configurations.

In this example, the lateral deflection of the spring element 114 in the lockout and release configurations has a different magnitude. This may provide that different applied forces are required to move between the positions. In particular, the spring element 114 is laterally deflected to a greater extent in the release configuration (FIG. 4A) than in the lockout configuration (FIG. 5A), such that that more applied force is required to move from the release configuration to the lockout configuration than from the lockout configuration to the release configuration.

When moving from the release configuration to the lockout configuration, a user may apply the actuation force directly or indirectly, for example using a button. However, when moving from the lockout configuration to the release configuration, a ‘first breath’ activation may be required. In this example, the regulator valve apparatus 102, and in particular the diaphragm 106 and linkage comprising flow regulation lever 105, are configured to apply sufficient force to the lockout mechanism 112 to move the lockout mechanism 112 from the lockout configuration to the release configuration, by pivoting the retention lever 116 and thereby laterally deforming the spring element 114 over its centre position on application of a first-breath pressure differential to the regulator valve apparatus 102.

In order to provide additional security in the lockout configuration, the valve assembly 200 further comprise a detent mechanism 125 configured to assist in securing the lockout mechanism 112 in the lockout configuration. As best shown in FIGS. 4A and 5A, the detent mechanism comprises a retaining feature 127 formed on the retention lever which engages a complementary retaining feature 108 of the regulator 100, to thereby assist in retaining the lockout mechanism 112 in the lockout configuration. In this example, the complementary feature may be a pivot pin 108 of a flow regulation lever 105 of the regulator valve apparatus 102. In other examples, other forms of detent mechanism may be provided to assist the spring element 114 in retaining the lockout mechanism 112 in the lockout configuration.

The valve assemblies of the present disclosure may provide an improved mechanism for disabling the flow of breathing gas through the regulator. The use of the mechanisms disclosed herein may provide improved tactile feedback to the user of the breathing apparatus while also providing a robust yet sensitive lockout function. The mechanism may provide improved safety as a user may engage the lockout mechanism more reliably and have more confidence in the lockout, particularly when wearing other personal protective equipment such as gloves, masks, and helmets, or in loud, emergency environments when visual and audible feedback may be less reliable or absent. Furthermore, the mechanisms described herein may provide a more secure lockout mechanism, with improved securing forces. Yet further, the mechanisms described herein may be simpler, more reliable, have a longer working life, and may require fewer bespoke parts.

It should be appreciated that the exemplary arrangement disclosed is one of many possible configurations for disabling the supply of breathing gas. Where alternative valve and regulator arrangements are used, it should be understood that the principles of the present disclosure could be applied and adapted to provide disablement of breathing gas flow.

1. A valve assembly for a lung demand regulator of a breathing apparatus comprising:
a regulator valve apparatus for regulating a flow of breathing gas, the regulator valve apparatus being actuatable between a closed position in which no flow is permitted and an open position in which flow is permitted;
a lockout mechanism configurable in: i) a lockout configuration in which the regulator valve apparatus is secured in the closed position, and ii) a release configuration in which the regulator valve apparatus is freely moveable;
wherein the lockout mechanism comprises an axially compressible spring element;
wherein the spring element is configured to be laterally deflected in a first direction in the lockout configuration and laterally deflected in a second direction different from the first direction in the release configuration; and
wherein lockout mechanism is configured such that the spring element is axially compressed during movement of the lockout mechanism between the release configuration and the lockout configuration.

2. A valve assembly for a lung demand regulator as claimed in claim 1, wherein a magnitude of lateral deflection of the spring element is different in the lockout configuration and the release configuration.

3. A valve assembly for a lung demand regulator as claimed in claim 1, wherein the first direction and the second direction are substantially opposing directions.

4. A valve assembly for a lung demand regulator as claimed in claim 1, wherein the lockout mechanism comprises a pivotable lever in operative connection with the spring element such that angular movement of the pivotable lever adjusts lateral deflection of the spring element.

5. A valve assembly for a lung demand regulator as claimed in claim 4, wherein the pivotable lever is configured in a first angular position in the lockout configuration and configured in a second angular position in the release configuration.

6. A valve assembly for a lung demand regulator as claimed in claim 4, wherein the pivotable lever is pivotable about a pivot axis, the pivot axis being substantially perpendicular to an axial direction of the spring element.

7. A valve assembly for a lung demand regulator as claimed in claim 4, wherein the pivotable lever comprises a first lever arm for operative connection with the spring element, and a second lever arm configured to engage the regulator valve apparatus in the lockout configuration.

8. A valve assembly for a lung demand regulator as claimed in claim 4, wherein a first end of the spring element is secured in a fixed position and wherein a second end of the spring element is secured to the pivotable lever.

9. A valve assembly for a lung demand regulator as claimed in claim 8, wherein a housing of the lung demand regulator comprises a fixed spring seat configured to secure the first end of the spring element in a fixed position.

10. A valve assembly for a lung demand regulator as claimed in claim 8, wherein the pivotable lever comprises a lever spring seat configured to locate the second end of the spring element.

11. A valve assembly for a lung demand regulator as claimed in claim 4, further comprising a detent mechanism configured to at least partially secure the lockout mechanism in the lockout configuration.

12. A valve assembly for a lung demand regulator as claimed in claim 1, wherein the axially deformable spring element is a helical spring.

13. A valve assembly for a lung demand regulator as claimed in claim 1, wherein the lockout mechanism is configured to be moved from the release configuration to the lockout configuration by the application of force on an activation component of the lockout mechanism by a user, optionally wherein the activation component is a lever or button which is pressable by a user.

14. A lung demand regulator comprising a valve assembly according to claim 1.

15. A breathing apparatus comprising a lung demand regulator according to claim 14, and optionally further comprising a face mask for connection to the lung demand regulator.
